(19) United States
(12) Patent Application Publication
(10) Pub. No.: US 2008/0161998 A1
(43) Pub. Date: Jul. 3, 2008

(54) Heat dissipation control apparatus for data recording unit

(75) Inventor: Shinichi Yokoi, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/000,800

(22) Filed: Dec. 18, 2007

(30) Foreign Application Priority Data
Dec. 28, 2006 (JP) 2006-355962

(51) Int. Cl. G06F 7/06; B60H 1/00

(52) U.S. Cl. 701/36; 434/140

(57) ABSTRACT

A heat dissipation control apparatus includes a vehicle condition detection device for detecting an operating condition of a vehicle, an occupant detection device for detecting whether an occupant is in the vehicle, a temperature detection device for detecting a temperature of a data recoding unit mounted on the vehicle, a heat dissipation device for dissipating heat from the data recording unit, and a control device for controlling the heat dissipation device in accordance with the detected temperature of the data recoding unit, when the vehicle is in a stopped condition, the data recoding unit is in operation, and no occupant is in the vehicle.

### CROSS REFERENCE TO RELATED APPLICATION

This application is based on and incorporates herein by reference Japanese Patent Application No. 2006-355962 filed on Dec. 28, 2006.

### FIELD OF THE INVENTION

The present invention relates to a heat dissipation control apparatus for controlling dissipation of heat from a data recording unit, which records data outputted from data output devices such as audio-visual devices mounted on a vehicle.

### BACKGROUND OF THE INVENTION

Recently, the number of vehicle navigation apparatus having a large capacity storage device such as a hard disk drive has been increased. Further, a vehicle navigation apparatus has been proposed that includes a radio/television tuner and can record a radio/television broadcast received by the tuner on a hard disk drive. A vehicle navigation apparatus disclosed, for example, in JP-A-2002-176370 or JP-A-2003-281865 has a time shift function to continue to record data on a hard disk drive when an user leaves a vehicle for a short time of period. The user can play back the recorded data after returning to the vehicle.

A time shift function is achieved by a central processing unit (CPU) incorporated in a vehicle navigation apparatus. Typically, data is recorded on a hard disk drive after being compressed by the CPU. Because the CPU executes a large number of calculations to compress the data, processing load of the CPU is significantly increased. Accordingly, heat generated in the CPU is increased. Further, the time shift function is performed during a period of time when an user leaves a vehicle. Therefore, the time shift function is performed under a condition, where all windows of the vehicle are fully closed, and an air-conditioner of the vehicle is off. Since the heat generated in the CPU cannot be sufficiently dissipated, the CPU may overheat. As a result, the time shift function may be interrupted, and the data recorded on the hard disk may be damaged or lost.

### SUMMARY OF THE INVENTION

In view of the above-described problem, it is an object of the present invention to provide a heat dissipation control apparatus that controls dissipation of heat from a data recording unit mounted on a vehicle according to conditions of the vehicle.

A heat dissipation control apparatus includes a vehicle condition detection device for detecting an operating condition of a vehicle, an occupant detection device for detecting whether an occupant is in the vehicle, a temperature detection device for detecting a temperature of a data recoding unit mounted on the vehicle, a heat dissipation device for dissipating heat from the data recording unit, and a control device for controlling the heat dissipation device in accordance with the detected temperature of the data recoding unit, when the vehicle is in a stopped condition, the data recoding unit is in operation, and no occupant is in the vehicle.

According to the heat dissipation control apparatus, the control device controls the heat dissipation device, when no occupant is in the vehicle. In such an approach, the control device can control the heat dissipation device without consideration of sound generated as a result of the operation of heat dissipation device. Thus, the heat dissipation device is operated at a level enough to dissipate the heat from the data recording unit, so that the data recoding unit can continue to record the data without overheating.

### BRIEF DESCRIPTION OF THE DRAWINGS

The above and other objectives, features and advantages of the present invention will become more apparent from the following detailed description made with check to the accompanying drawings. In the drawings:

FIG. 1 is a block diagram illustrating a vehicle navigation apparatus according to an embodiment of the present invention;

FIG. 2 is a flow diagram illustrating a process performed by a central processing unit in the navigation apparatus of FIG. 1;

FIG. 3 is a flow diagram illustrating a part of the process of the FIG. 2;

FIG. 4A is a diagram illustrating a main body and a monitor device of the navigation apparatus when the monitor device is in a normal position, and FIGS. 4B, 4C are diagrams illustrating the main body and the monitor device of the navigation apparatus after the monitor device moves to a ventilation position from the normal position; and

FIGS. 5A, 5B are diagrams illustrating setting screens for allowing an occupant to select whether to enable or disable the central processing unit to control a window.

### DETAILED DESCRIPTION OF THE PREFERRED EMBODIMENT

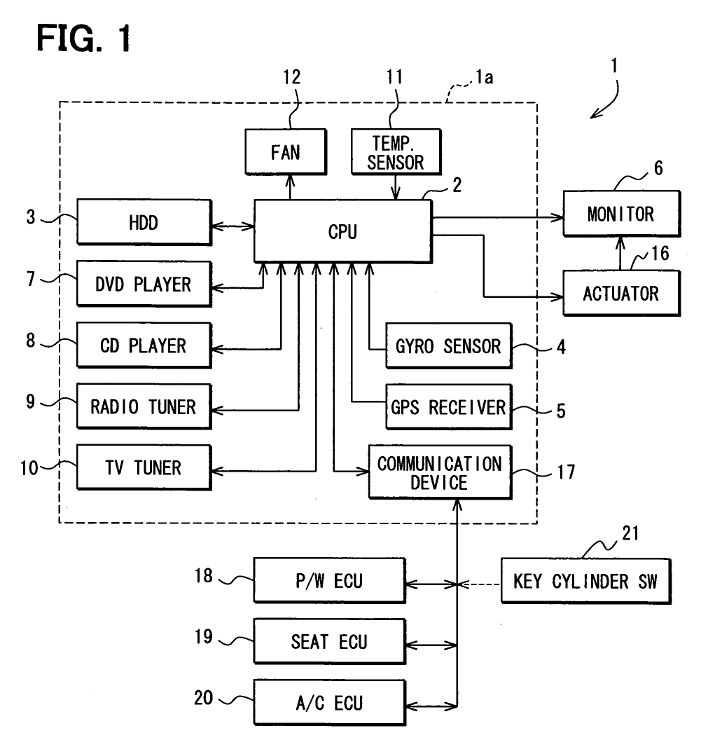

Referring to FIG. 1, a navigation apparatus 1 according to an embodiment of the present invention includes a main body 1a and a monitor device 6. The main body 1a mainly includes a central processing unit (CPU) 2, a hard disc drive (HDD) 3, a gyroscope 4, and a global positioning system (GPS) receiver 5.

The CPU 2 controls the entire operation of the navigation apparatus 1. The HDD 3 stores map data. The gyroscope 4 detects an attitude (heading direction) of the vehicle. The GPS receiver 5 receives signals from GPS satellites and detects a current location of a vehicle based on the received signals. When a destination is set, the CPU 2 calculates a route path to the destination and causes the monitor device 6 to display a map, where the current location and the route path are overlaid.

The navigation apparatus 1 further includes audio-visual devices such as a DVD player 7, a CD player 8, a radio tuner 9, and a television (TV) tuner 10. When a DVD or a CD is played back by using the DVD player 7 or the CD player 8, visual data stored in the DVD or CD is displayed on the monitor device 6, and audio data stored in the DVD or CD is outputted through a speaker (not shown). A radio broadcast received by the radio tuner 9 is outputted through the speaker. Likewise, a TV broadcast received by the TV tuner 10 is displayed on the monitor device 6 and outputted through the speaker.

The CPU 2 has audio and video recording functions for recoding outputs of the audio-visual devices. Specifically, the CPU 2 converts audio and video signals outputted from the audio-visual devices (in particular, the radio and TV tuners 9, 10) into digital data. The CPU 2 performs processing (e.g., compression) of the digital data as needed. Then, the CPU 2 writes the digital data to the HDD 3. Further, the CPU 2 has a time shift function that allows the recoding to be continued even after an ignition switch of a vehicle is switched off, i.e., even after the vehicle is in a stopped condition.

The navigation apparatus 1 further includes a temperature sensor 11 for detecting a temperature of the CPU 2 and a fan device 12 for dissipating heat inside the main body 1a of the navigation apparatus 1. The fan device 12 is driven and controlled by the CPU 2.

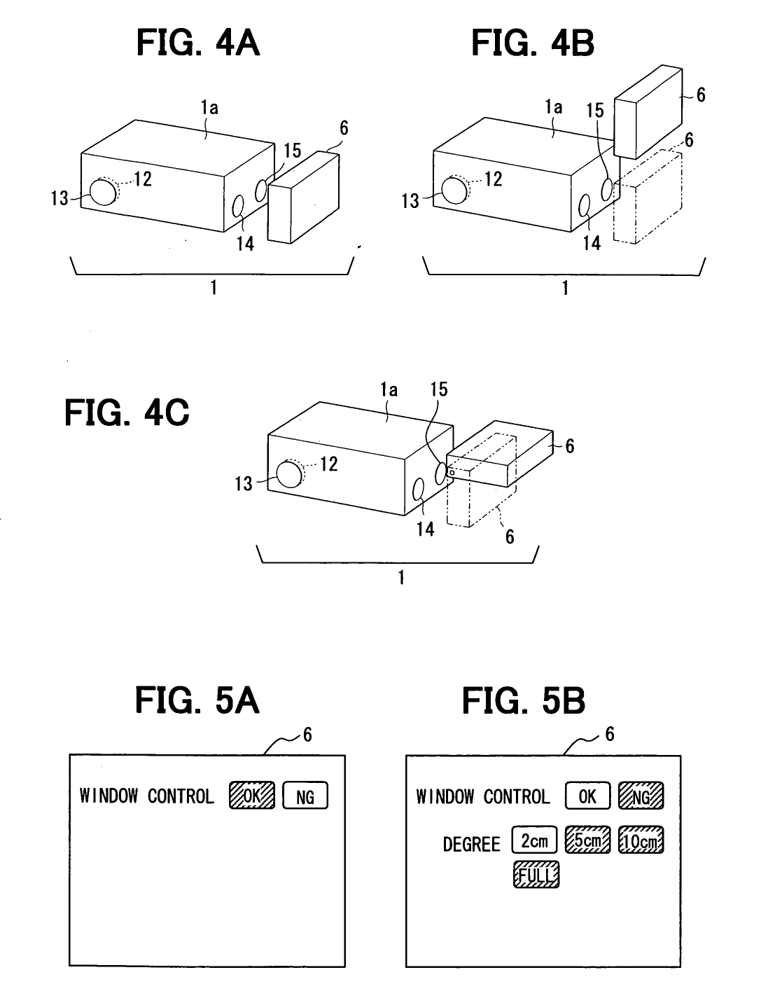

As shown in FIGS. 4A-4C, the navigation apparatus 1 is constructed such that the monitor device 6 can be mechanically driven to be separated from the main body 1a. The main body 1a has a shape like a rectangular box. A first ventilation hole 13 is formed on one side surface of the main body 1a, and second and third ventilation holes 14, 15 are formed on a front surface of the main body 1a. The fan device 12 is placed inside the main body 1a. When the fan device 12 is driven (i.e., rotated), air is introduced inside the main body 1a through the second and third ventilation holes 14, 15 and exhausted outside the main body 1a through the first ventilation hole 13. The monitor device 6 is installed on the front surface side of the main body 1a and can be displaced (i.e., can change its position) relative to the main body 1a by an actuator 16, which is shown in FIG. 1 and not shown in FIGS. 4A-4C.

In normal operations, the monitor device 6 is in a normal position, where the monitor device 6 is positioned on the front surface side of the main body 1a to block the second and third ventilation holes 14, 15. In the normal position, although the second and third ventilation holes 14, 15 are blocked, the air can be introduced inside the main body 1a through slit holes (not shown) formed on the main body 1a.

In heat dissipation operations, the CPU 2 causes the monitor device 6 to move from the normal position to a ventilation position. In the ventilation position, the second and third ventilation holes 14, 15 are not blocked so that the air can be introduced inside the main body 1a through the second and third ventilation holes 14, 15. For example, the monitor device 6 moves from the normal position to the ventilation position as follows. After moving away from the front surface of the main body 1a as shown in FIG. 4A, the monitor device 6 moves upward as shown in FIG. 4B. Alternatively, as shown in FIG. 4C, the monitor device 6 may pivot upward about a pivot pin provided on the top end thereof by the actuator 16 not to block the second and third ventilation holes 14, 15.

Returning to FIG. 1, the navigation apparatus 1 further includes a communication device 17 that serves as an communication interface with an in-vehicle local-area network (LAN) such as a local interconnect network (LIN), or a controller area network (CAN) Each of “LIN” and “CAN” is a registered trademark. The CPU 2 can communicate with a power window (PAN) electronic control unit (ECU) 18, a seat ECU 19, and an air-conditioner (A/C) CPU 20 through the communication device 17.

The power window ECU 18 controls an actuator (not shown) to open/close a window of a door or a roof of the vehicle. Further, the power window ECU 18 can detect open/close condition of the window. The seat ECU 19 is installed on each seat of the vehicle and includes a sensor (not shown) such as a pressure sensor. The seat ECU 19 detects, based on the sensor output, whether each seat is occupied. The air-conditioner CPU 20 turns on/off an air-conditioner of the vehicle and controls the amount of air supplied from the air-conditioner. The CPU 2 receives a key position signal from a key cylinder switch 21 through the in-vehicle LAN. The key position signal indicates which position the ignition key is in. Thus, vehicle conditions can be detected through the key cylinder switch 21.

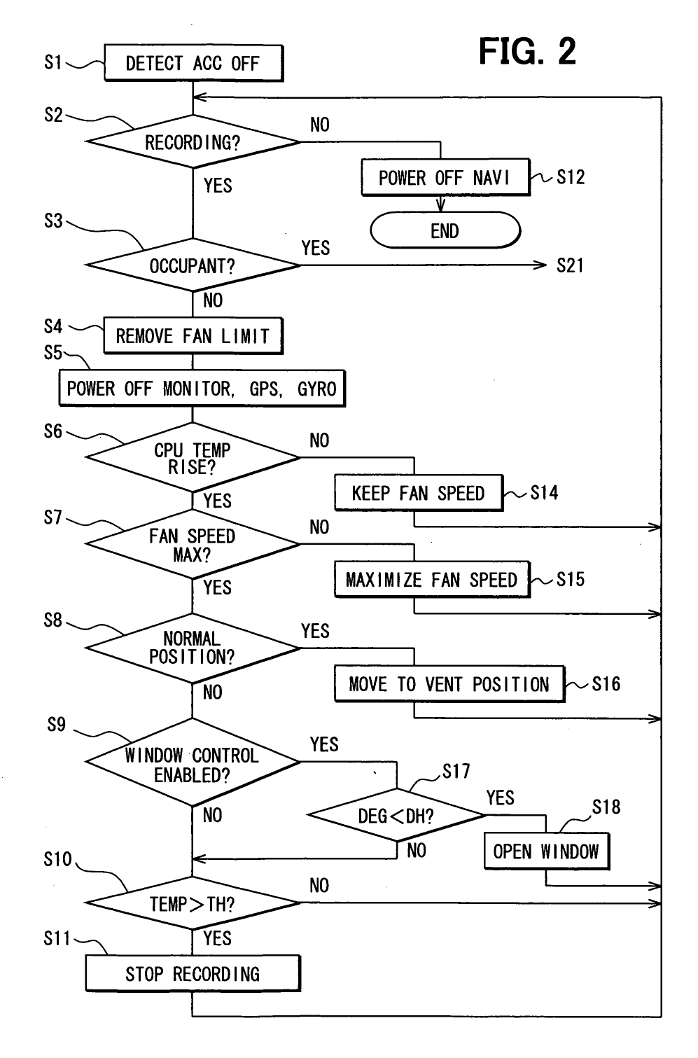

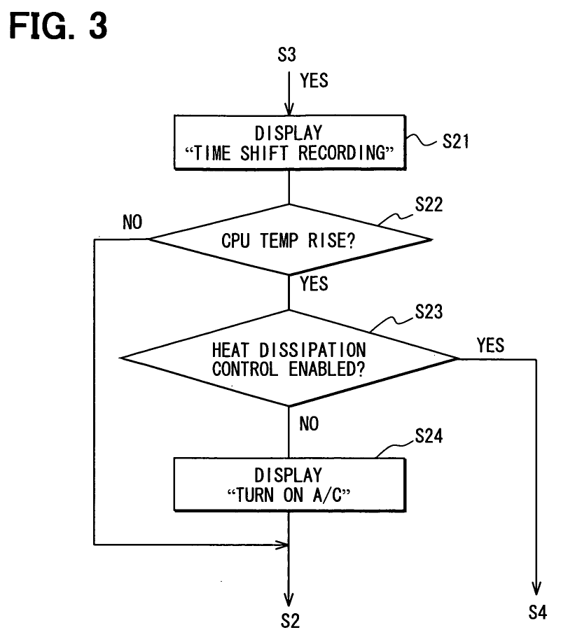

The CPU 2 executes a process illustrated by flow diagrams of FIGS. 2, 3. When the CPU 2 detects that the ignition key is turned to an accessory off (ACC OFF) position at step S1, the process proceeds to step S2, where the CPU 2 determines whether recoding of data is being performed now. If the recording is not being performed now corresponding to NO at step S2, the CPU 2 powers off the navigation apparatus 1, and the process is ended. On the other hand, If the recording being performed now corresponding to YES at step S2, the CPU 2 performs the time shift function to continue the recording. Then, the process proceeds to step S3, where the CPU 2 determines based on an output signal of the seat ECU 19 whether at least one seat is occupied.

If at least one seat is occupied corresponding to YES at step S3, the process jumps to step S21 shown in FIG. 3. On the other hand, If all seats are empty, i.e., no one is in the vehicle corresponding to NO at step S3, the process proceeds to step S4, where the CPU 2 disables a fan control function set to the fan device 12. When the fan control function is enabled, a rotational speed of the fan device 12 is limited to reduce an unpleasant noise produced by the fan device 12. In contrast, when the fan control function is disabled, the rotational speed of the fan device 12 is not limited so that the fan device 12 can produce the large amount of air flow.

After step S4, the process proceeds to step S5, where the CPU 2 turns off the screen of the monitor device 6 and interrupts power supply to functional blocks of the vehicle navigation apparatus, such as the gyroscope 4 and the GPS receiver 5, in order to reduce power consumption as much as possible.

After step S5, the process proceeds to step S6, where the CPU 2 detects its own temperature based on an output signal of the temperature sensor 11 and calculates a difference between a present temperature and a previous temperature. The CPU 2 determines based on the difference whether the temperature is increased by at least a predetermined value. In the present embodiment, for example, the predetermined value is set between 3 degrees Celsius and 5 degrees Celsius.

If the rate of increase in the temperature of the CPU 2 does not exceed the predetermined value corresponding to NO at step S6, the process proceeds to step S14, where the CPU 2 keeps the rotational speed of the fan device 12 unchanged. Then, the process returns to step S2. On the other hand, If the rate of increase in the temperature of the CPU 2 exceeds the predetermined value corresponding to YES at step S6, the process proceeds to step S7.

At step S7, the CPU 2 determines whether the rotational speed of the fan device 12 is set to a maximum level. If the rotational speed of the fan device 12 is not set to the maximum level corresponding to NO at step S7, the process proceeds to step S15, where the CPU 2 maximizes the rotational speed of the fan device 12 so that the fan device 12 can produce the large amount of air flow. Then, the process returns to step S2. On the other hand, if the rotational speed of the fan device 12 is set to the maximum level corresponding to YES at step S7, the process proceeds to step S8.

At step S8, the CPU 2 determines whether the monitor device 6 is in the normal position, where the ventilation holes 14, 15 of the main body 1a are blocked by the monitor device 6. If the monitor device 6 is in the normal position corresponding to YES at step S8, the process proceeds to step S16, where the CPU 2 causes the monitor device 6 to move from the normal position to the ventilation position, where the ventilation holes 14, 15 of the main body 1a are not blocked by the monitor device 6. Then, the process returns to step S2. On the other hand, if the monitor device 6 is in the ventilation position corresponding to NO at step S8, the process proceeds to step S9.

At step S9, the CPU 2 determines whether a window control function is enabled or disabled.

The window control function is described below with reference to FIGS. 5A, 5B. When the window control function is enabled, the CPU 2 is allowed to open the window of the door or the roof of the vehicle within a maximum allowable degree DH of opening. In such an approach, the air can be introduced inside the vehicle through the opened window so that the navigation apparatus 1 can be cooled.

In the present embodiment, the window control function can be set enabled or disabled through a setting screen displayed on the monitor device 6. For example, the setting screen can be selected from a main menu of the monitor device 6. FIG. 5A shows the setting screen displayed on the monitor device 6. In FIG. 5A, the window control function is set disabled (i.e., NG). In contrast, when the window control function is set enabled (i.e., OK), the setting screen changes so that the maximum allowable degree DH of opening can be set through the setting screen. For example, the maximum allowable degree DH of opening can be selected among 2 centimeters (cm), 5 cm, 10 cm, and a full open (i.e., FULL). In FIG. 5B, the maximum allowable degree DH of opening is set to 2 cm.

Returning to FIG. 2, if the window control function is enabled as shown in FIG. 5B corresponding to YES at step S9, the process proceeds to step S17. At step S17, the CPU 2 detects a present degree DEG of opening of the window and determines whether the detected degree DEG of opening exceeds the maximum allowable degree DH of opening. If the detected degree DEG of opening does not exceed the maximum allowable degree DH of opening corresponding to YES at step S18, the process proceeds to step S18. At step S18, the CPU 2 causes the power window ECU 18 to open the window by a predetermined degree (e.g., one centimeter) of opening. Then, the process returns to step S2.

On the other hand, if the window control function is disabled as shown in FIG. 5A corresponding to NO at step S9, or if the detected degree DEG of opening exceeds the maximum allowable degree DH of opening corresponding to NO at step S18, the process proceeds to step S10. At step S10, the CPU 2 detects its own temperature TEMP based on the output signal of the temperature sensor 11 and determines whether the detected temperature TEMP exceeds a threshold temperature TH, which is generally equal to a maximum operating temperature of the CPU 2.

If the detected temperature TEMP does not exceed the threshold temperature TH corresponding to NO at step S10, the process returns to step S2. On the other hand, if the detected temperature TEMP exceeds the threshold temperature TH corresponding to YES at step S10, the process proceeds to step S11, where the CPU 2 causes the monitor device 6 to return to its initial position (e.g., the normal position) and causes the window to return to its initial position (e.g., full closed position). Then, the CPU 2 stops the time shift function to stop the recording, and the process returns to step S2.

Referring to further to FIG. 3, if at least one seat is occupied corresponding to YES at step S3 shown in FIG. 2, the process proceeds to step S21 shown in FIG. 3. At step S21, the CPU 2 causes to the monitor device 6 to display a message, a symbol, or the like indicating that the time shift function is being performed now to continue the recording. Then, the process proceeds to step S22, where the CPU 2 detects its own temperature TEMP based on the output signal of the temperature sensor 11 and calculates the difference between the present temperature and the previous temperature. The CPU 2 determines based on the difference whether the rate of increase in the temperature of the CPU 2 exceeds the predetermined value.

If the rate of increase in the temperature of the CPU 2 does not exceed the predetermined value corresponding to NO at step S22, the process returns to step S2. On the other hand, if the rate of increase in the temperature of the CPU 2 exceeds the predetermined value corresponding to YES at step S22, the process proceeds to step S23. At step S23, the CPU 2 causes the monitor device 6 to display a setting screen that allows the occupant to select to enable or disable a heat dissipation control. The CPU 2 waits for the occupant to select for a predetermined period of time.

If the user selects to disable the heat dissipation control or the user does not select (i.e., does not respond) within the predetermined period of time corresponding to NO at step S23, the process proceeds to step S24. At step S24, the CPU 2 causes the monitor device 6 to display a display screen that urges the occupant to switch on, for example, an air-conditioner to dissipate the heat. Thus, the occupant can control the temperature inside the vehicle. Then, the process returns to step S2 shown in FIG. 2.

As described above, according to the present embodiment, the CPU 2 of the navigation apparatus 1 controls the fan device 12 in accordance with its own temperature, when the vehicle is in the stopped condition, the time shift function is in operation to record the data being received by the tuners 9, 10 on the HDD 3, and no one is in the vehicle. In such an approach, the heat generated in the CPU 2 is suitably dissipated so that the CPU 2 can continue the time shift function without overheating.

Typically, a vehicle navigation apparatus has a hard disk drive and a fan device. Therefore, the present invention can be applied to a vehicle navigation apparatus. The CPU 2 interrupts power supply to the functional blocks of the navigation apparatus 1 to reduce power consumption as much as possible, when the vehicle is in the stopped condition.

The CPU 2 can keep the rotational speed of the fan device 12 unchanged, when the rate of increase in the temperature of the CPU 2 is within a predetermined range. The CPU 2 can maximize the rotational speed of the fan device 12, when the rate of increase in the temperature of the CPU 2 is outside the predetermined range. Thus, when the temperature of the CPU 2 rises sharply, the amount of the air flow supplied by the fan device 12 is increased to efficiently dissipate the heat generated by the CPU 2.

When the rate of increase in the temperature of the CPU 2 is outside the predetermined range, the CPU 2 can cause the monitor device 6 to move to the ventilation position, where the monitor device 6 is separated from the main body 1a not to block the ventilation holes 14, 15. In such an approach, the air flow between the inside and outside of the main body 1a is increased so that the heat in the CPU 2 can be efficiently dissipated.

The CPU 2 can open the window of the vehicle to introduce and exhaust air inside and outside the vehicle, when the rate of increase in the temperature of the CPU 2 is outside the predetermined range. Thus, the temperature inside the vehicle can be reduced so that the heat in the CPU 2 can be efficiently dissipated. The occupant can select to enable or disable the CPU 2 to open the window, for example, in consideration of security, weather, or the like. Also, the occupant can set a degree of opening of the window in consideration of security, weather, or the like.

The CPU 2 stops the time shift function to avoid overheating, when the temperature of the CPU 2 exceeds the threshold temperature.

The CPU 2 causes the monitor device 6 to display the setting screen that allows the occupant to select whether to enable or disable the heat dissipation control, when the rate of increase in the temperature of the CPU 2 is outside the predetermined range, the time shift function is in operation, and the occupant is in the vehicle. The heat dissipation control corresponds to steps S4-S18 in the flow diagram of FIG. 2.

The CPU 2 causes the monitor device 6 to display the display screen that leads the occupant to switch on, for example, an air-conditioner of the vehicle to dissipate the heat, if the occupant selects to disable the fan control function or the occupant does not respond to the setting screen within the predetermined period of time. Thus, the occupant can control the temperature inside the vehicle to prevent the CPU 2 from overheating.

(Modifications)

The embodiment described above may be modified in various ways. For example, step S4 can be eliminated from the flow diagram of FIG. 2. The occupant can be detected by using other sensors such as an infrared sensor instead of the seat ECU 19 (i.e., pressure sensor). The time shift function may be used to record data from one of an audio device and a visual device. The monitor device 6 may be fixed to predetermined position with respect to the main body 1a. The rotational speed of the fan device 12 may be controlled based on whether the temperature TEMP of the CPU 2 exceeds a predetermined threshold temperature. Step S9 and/or step S17 can be eliminated from the flow diagram of FIG. 2. Steps S21, S23, S24 may be performed with voice notification. Other heat dissipation devices than the fan device 12 can be used. For example, instead of the fan device 12, a heatsink with a coolant may be used to dissipate heat. The present invention can be applied to a data recoding unit that is not incorporated in a vehicle navigation apparatus.

Such changes and modifications are to be understood as being within the scope of the present invention as defined by the appended claims.

What is claimed is:

1. A heat dissipation control apparatus for controlling dissipation of heat from a data recoding unit mounted on a vehicle, the data recoding unit recording data outputted from a data production device on storing means, the apparatus comprising:
vehicle condition detection means that detects an operating condition of the vehicle;
occupant detection means that detects whether an occupant is in the vehicle;
temperature detection means that detects a temperature of the recoding unit;
heat dissipation means that dissipates the heat from the recording unit; and
control means that controls the heat dissipation means in accordance with the detected temperature of the data recoding unit, when the vehicle is in a stopped condition, the data recoding unit is in operation, and no occupant is in the vehicle.

2. The apparatus according to claim 1,
wherein the heat dissipation means includes a fan device for generating air flow,
wherein the control means keeps a rotational speed of the fan device unchanged, when a rate of increase in the detected temperature is within a predetermined range, and
wherein when the rate of increase in the detected temperature is outside the predetermined range, the control means maximizes the rotational speed of the fan device.

3. The apparatus according to claim 1,
wherein the recoding unit includes a monitor device placed outside a main body of the recording unit and drive means for displacing the monitor device relative to the main body of the recording unit, and
wherein when a rate of increase in the detected temperature of the recoding unit is outside the predetermined range, the control means controls the drive means so that the monitor device moves to a ventilation position, where air flow between an inside and an outside of the main body is increased.

4. The apparatus according to claim 3,
wherein the main body of the recoding unit has a slit and a plurality of ventilation holes, each communicating between the inside and outside of the main body,
wherein the plurality of ventilation holes includes an inlet hole for introducing air into the inside of the main body and an outlet hole for exhausting the air to the outside of the main body,
wherein when the rate of increase in the detected temperature of the recoding unit is within the predetermined range, the control means controls the drive means so that the monitor device is in a normal position, where the inlet hole is blocked by the monitor device,
wherein when the monitor device is in the normal position, the air is exhausted to the outside of the main body through the slit, and
wherein when the rate of increase in the detected temperature of the recoding unit is outside the predetermined range, the control means controls the drive means so that the monitor device is in the ventilation position, where the inlet hole is open to the outside of the main body to increase the air flow.

5. The apparatus according to claim 1,
wherein when a rate of increase in the detected temperature of the recoding unit is outside a predetermined range, the control means opens a window of the vehicle.

6. The apparatus according to claim 5, further comprising:
first setting means for allowing the occupant to select whether the window is allowed to be opened, and
wherein the control means opens the window of the vehicle, only when the window is allowed to be opened.

7. The apparatus according to claim 5, further comprising:
second setting means for allowing the occupant to set a degree of opening of the window, and
wherein the control means opens the window in accordance the set degree.

8. The apparatus according to claim 1,
wherein the control means causes the recording unit to stop recoding the data, when the detected temperature of the recoding unit exceeds a predetermined temperature.

9. The apparatus according to claim 1,
wherein the control means provides a first notice to the occupant, when a rate of increase in the detected temperature of the recoding unit is outside a predetermined range, the vehicle in the stopped condition, the data recoding unit is in operation, and the occupant is in the vehicle,
wherein the first notice leads the occupant to select whether to control the heat dissipation means, and
wherein the control means controls the heat dissipation means, when the occupant selects to control the heat dissipation means.

10. The apparatus according to claim 9,
wherein the control means provides a second notice to the occupant, when the occupant selects not to control the heat dissipation means or when the occupant does not respond to the first notice for a predetermined period of time, and
wherein the second notice leads the occupant to perform air-conditioning in the vehicle.

11. The apparatus according to claim 1,
wherein the heat dissipation control apparatus is incorporated in a vehicle navigation apparatus.

12. The apparatus according to claim 11,
wherein the control means interrupts power supply to a functional block of the navigation apparatus, when the vehicle in the stopped condition, and
wherein the functional block is necessary to perform navigation.

13. The apparatus according to claim 1,
wherein data production device includes at least one of a audio device and a video device.

14. A heat dissipation control apparatus for controlling dissipation of heat from a data recoding unit mounted on a vehicle, the recoding unit recording data outputted from a data production device on a storing device, the apparatus comprising:
a vehicle condition detection device that detects an operating condition of the vehicle;
an occupant detection device that detects whether an occupant is in the vehicle;
a temperature detection device that detects a temperature of the recoding unit;
a heat dissipation device that dissipates the heat from the recording unit; and
a control device that controls the heat dissipation device in accordance with the detected temperature of the data recoding unit, when the vehicle is in a stopped condition, the data recoding unit is in operation, and no occupant is in the vehicle.
